(19) United States
(12) Patent Application Publication
(10) Pub. No.: US 2026/0322278 A1
(43) Pub. Date: Oct. 15, 2026

(54) TWO STAGE AUXILIARY POWER SUPPLY

(71) Applicant: UT-Battelle, LLC, Oak Ridge, TN (US)

(72) Inventors: Rajendra Prasad Kandula, Knoxville, TN (US); Marcio Luiz Magri Kimpara, Knoxville, TN (US)

(21) Appl. No.: 19/464,909

(22) Filed: Jan. 30, 2026

Related U.S. Application Data
(60) Provisional application No. 63/752,609, filed on Jan. 31, 2025.

(51) Int. Cl. H02M 3/335; H02M 1/088; H02M 1/36; H02M 3/00

(52) U.S. Cl. CPC H02M 3/33571; H02M 1/088; H02M 1/36; H02M 3/01

(57) ABSTRACT

A power supply with a startup circuit operable to facilitate operation is disclosed. The startup circuit includes a capacitive divider circuit arranged to charge based on power from an input port. The startup circuitry may be operable to delay supply of power to a control circuit relative to initial receipt of power from the input port based on a charge state of a capacitor of the capacitive divider.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of power conversion, and more particularly to a multi-stage auxiliary power supply for wide-input voltage range and medium-voltage applications.

### BACKGROUND

Applications involving medium-voltage (MV) levels are gaining popularity in power electronics-based infrastructures, such as electronic vehicle (EV) charging stations, solid state power substations (SSPS), and renewable energy installations. In these applications, auxiliary power supplies (APS) are ancillary systems that provide power to various subsystems, including communications, control, cooling, and sensing.

Among the topologies for MV systems, a modular multilevel converter stands out. In such structures, many sub-modules (SM) are stacked in series, hence the APS can be designed to be connected directly on the DC-link bus, enabling its integration onto the SMs. This approach results in a more complete building block, simplifying the cabling and the modular architecture. Nevertheless, due to potential voltage fluctuations in the DC-link capacitor, the APS often needs to operate effectively across a broad input voltage range.

The wide input range conditions at MV levels can present a significant issue for APS with a single-stage DC-DC converter, particularly due to the voltage step-down ratio. Therefore, a two-stage solution can be utilized. One conventional configuration has adopted a flyback topology in the front-end of a dual-stage APS. Although the flyback is a mature structure, an LLC resonant converter may be used instead for DC-DC switching power supplies due to advantages, such as high efficiency, low electromagnetic interference (EMI), and superior power density. A conventional two-stage APS with double resonant tank LLC converter has been used; however, this configuration is for low-voltage applications and the input voltage range is narrow.

One drawback associated with resonant converters is their frequency modulation-based control, which adds complexity to the configuration when these converters are applied with a wide input voltage range. This complexity arises because a broad input voltage range demands a wide frequency range.

### SUMMARY

In general, one innovative aspect of the subject matter described herein can be embodied in a power supply that includes an input port configured to be connected to DC voltage in a medium-voltage range of 600-2000 V. The power supply may include a resonant circuit having a resonant frequency in a frequency range of 10-300 kHz, a control circuit, and a DC/AC inverter electrically connected between the input port and the resonant circuit and operationally connected to the control circuit.

The control circuit may be configured to operate the DC/AC inverter at a switching frequency that matches the resonant frequency, where the DC/AC inverter may be configured to produce, from the DC voltage across the input port, a voltage square waveform at the switching frequency for exciting the resonant circuit.

The power supply may include a transformer including a primary winding electrically connected to the resonant circuit and configured to receive a primary voltage waveform at the switching frequency from the resonant circuit excited with the voltage square waveform. The transformer may include a secondary winding magnetically coupled with the primary winding and configured to produce a secondary voltage waveform at the switching frequency and corresponding to the primary voltage waveform.

The power supply may include a DC/DC converter and an AC/DC rectifier electrically connected between the secondary winding and the DC/DC converter. The AC/DC rectifier may be configured to produce, from the secondary voltage waveform across the secondary winding, an unregulated DC voltage. The power supply may include an output port electrically connected to the DC/DC converter, where the DC/DC converter may be configured to regulate the unregulated DC voltage, and provide regulated DC voltage across the output port.

The power supply may include startup circuitry operable to supply power to the control circuit to initiate supply of control signals to operate the DC/AC inverter at the switching frequency. The startup circuitry may include a capacitive divider circuit with a first capacitor and a second capacitor operable to charge based on power from the input port. The startup circuitry may be operable to delay supply of power to the control circuit relative to initial receipt of power from the input port based on a charge state of the second capacitor.

The foregoing and other embodiments can each optionally include one or more of the following features, alone or in combination. In particular, one embodiment includes all the following features in combination.

In some aspects, by delaying supply of power to the control circuit, the startup circuitry may delay initiation of supply of control signals to operate the DC/AC inverter at the switching frequency.

In some aspects, the startup circuitry may power the control circuit until a tertiary winding produces a tertiary voltage waveform and turns itself off once the tertiary winding produces the tertiary voltage waveform.

In some aspects, the startup circuitry may delay supply of power to the control circuit until the second capacitor of the capacitive divider circuit reaches a threshold charge voltage.

In some aspects, the startup circuitry may operate independent of the resonant circuit, the control circuit, and the DC/AC inverter.

In some aspects, the transformer may include a tertiary winding magnetically coupled with the primary winding and configured to produce a tertiary voltage waveform at the switching frequency and corresponding to the primary voltage waveform. The power supply may include another DC/DC converter and another AC/DC rectifier electrically connected between the tertiary winding and the other DC/DC converter, where the other AC/DC rectifier may be configured to produce, from the tertiary voltage waveform across the tertiary winding, another unregulated DC voltage. The other DC/DC converter may be configured to regulate the other unregulated DC voltage and power the control circuit with another regulated DC voltage.

In some aspects, the other regulated DC voltage used by the other DC/DC converter to power the control circuit may be about 17 V.

In some aspects, the startup circuitry may be configured to power the control circuit until the tertiary winding produces the tertiary voltage waveform and to turn itself off once the tertiary winding produces the tertiary voltage waveform.

In some aspects, the DC/DC converter may be configured as a buck converter.

In some aspects, the resonant circuit may be configured as an LLC resonator.

In some aspects, the regulated DC voltage provided by the DC/DC converter across the output port may be about 24 V.

In general, one innovative aspect of the subject matter described herein can be embodied in a power supply including an input port configured to be connected to DC voltage, a resonant circuit having a resonant frequency, a control circuit, and an inverter electrically connected between the input port and the resonant circuit and operationally connected to the control circuit. The control circuit may be configured to operate the inverter at a switching frequency aligned with the resonant frequency.

The power supply may include a transformer with a primary winding electrically connected to the resonant circuit and configured to receive a primary voltage waveform at the switching frequency from the resonant circuit. The transformer may include a secondary winding magnetically coupled with the primary winding and configured to produce a secondary voltage waveform at the switching frequency and corresponding to the primary voltage waveform.

The power supply may include a load and a rectification circuit electrically connected between the secondary winding and the load, where the rectification circuit may be configured to supply power to the load based on power derived from the secondary voltage waveform across the secondary winding.

The foregoing and other embodiments can each optionally include one or more of the following features, alone or in combination. In particular, one embodiment includes all the following features in combination.

In some aspects, by delaying supply of power to the control circuit, the startup circuitry may delay initiation of supply of control signals to operate the inverter at the switching frequency.

In some aspects, the startup circuitry may power the control circuit until a tertiary winding produces a tertiary voltage waveform and turns itself off once the tertiary winding produces the tertiary voltage waveform.

In some aspects, the control circuit may obtain power during operation based on the tertiary voltage waveform output from the tertiary winding.

In some aspects, the startup circuitry may delay supply of power to the control circuit until the second capacitor of the capacitive divider circuit reaches a threshold charge voltage.

In some aspects, the startup circuitry may operate independent of the resonant circuit, the control circuit, and the inverter.

In some aspects, the inverter circuitry may include half-bridge driver circuitry.

In some aspects, the load may include a DC/DC converter operable to regulate power output from the rectification circuitry for supply to an output port.

In some aspects, the resonant circuit may be an LLC resonator.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a power supply according to one embodiment.

FIG. 2 shows a startup circuit of the power supply of FIG. 1.

FIG. 3 shows a block diagram of a power supply according to one embodiment.

FIG. 4 shows a plot of aspects of a power supply according to one embodiment.

FIG. 5 shows a zoomed view of the plot of FIG. 4.

FIG. 6 shows a plot of aspects of a power supply according to one embodiment.

### DESCRIPTION

One embodiment according to the present disclosure includes a power supply with a startup circuit operable to facilitate operation. The power supply may vary from application to application. In one embodiment, the power supply may correspond to a two-stage APS providing 24 V output over a wide input DC voltage range, such as from 600 V to 2 kV. The medium-voltage to low-voltage scale may be addressed by a DC transformer (DCX) stage, while the low-voltage tight regulation may be provided by a cascaded second stage. This approach may be used in MV applications. As described herein, such a power supply may be configured differently depending on the application.

In one embodiment, the power supply may include an LLC resonant DCX module configured to operate at a fixed switching frequency, with full output voltage regulation not being required in a front-end stage. Voltage regulation can be accomplished in a cascaded second stage. Although the overall efficiency in this configuration may experience a slight compromise, this approach greatly simplifies the control method because as a DCX the resonant tank LLC may provide unregulated voltage with no feedback loop and no sensors. Control may be simplified for APS applications to ensure high reliability and stability.

In addition, a startup methodology is provided to enable initial operation of control circuitry of the power supply when the input voltage reaches a certain value. After a few switching signals are generated, self-powered operation takes place for the power supply to maintain the operation of the power supply, such as based on output from a tertiary winding in a transformer of the power supply.

The power supply according to one embodiment is configured to operate based on a 0.6-2 kV DC input voltage range and convert this input power to a standard 24 V output. The rated power is 100 W—but both the input range, output range, and rated power output may vary based on the configuration and application.

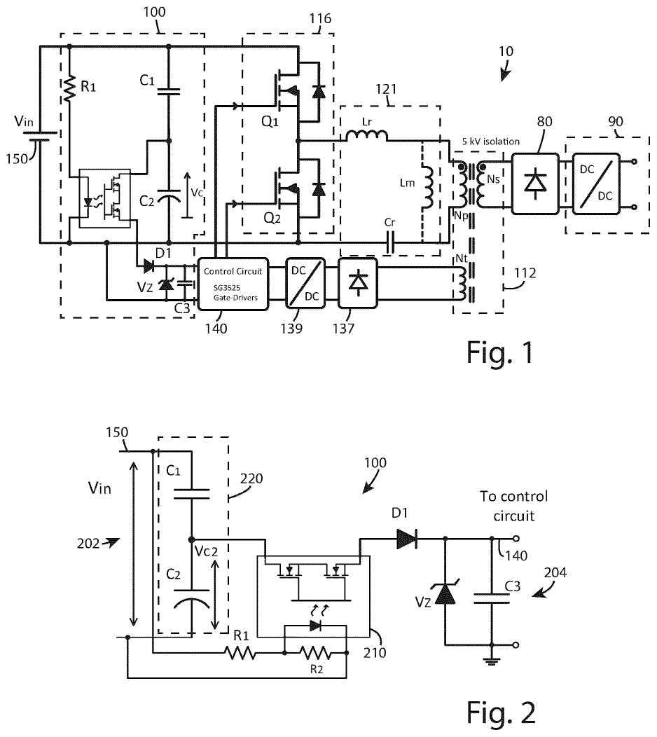

A power supply 10 in accordance with one embodiment is shown in FIGS. 1-3. The power supply 10 may be operable as a two-stage auxiliary power supply (APS), potentially providing 24 V output over a wide input DC voltage range, from 600 V to 2 kV. The power supply 10 may accommodate a medium-voltage to low-voltage scale by a DC transformer (DCX) stage, while low-voltage tight regulation may be provided in a cascaded second stage. Such a configuration may provide an efficient configuration of an APS in MV applications. The power supply 10 according to one embodiment may include a startup circuit 100 configured to facilitate operation during startup—e.g., after power from a power source 150 is initially received.

The power supply 10, according to one embodiment, may include a first stage, which includes an LLC-DCX module, where a half-bridge configuration generates a high-frequency square waveform from the DC input voltage and excites a resonant LC tank.

In one embodiment, the power supply 10 may be configured to provide a more sinusoidal-like current waveform to a transformer, which may scale the voltage down and provide primary to secondary isolation.

The power supply 10 in one embodiment may include a resonant module controlled in open loop manner, at a fixed frequency and 50% duty cycle. This strategy may substantially eliminate issues with high-frequency control and can have higher efficiency by setting the switching frequency around the series resonant frequency for all operating points.

The second stage of a power supply 10 according to one embodiment includes a DC/DC non-isolated low-voltage step-down converter, for instance, a synchronous Buck converter. Moreover, the first stage can be used to provide an isolated second level distribution bus for different point-of-load converters (POLs) used to obtain other non-isolated low-voltage levels.

In other words, the power supply 10 according to one embodiment may be configured for one or more of the following: fixed switching frequency operation of an LLC-DCX, which releases the control of the resonance stage to accommodate a wide input range; operation with a switching frequency set at the resonant frequency point, enabling high efficiency; simple and cost-efficient control circuitry; no sensors in the MV stage; and no feedback loop, which would otherwise add extra capacitive coupling between the secondary and primary sides.

The power supply 10 may be configured to receive power from the power source 150 (e.g., a DC power source or an AC power source) and convert this power for supply to the DC/DC converter 90 or any other type of load, which may be any type of component or device configured to receive power. As noted, the power source 150 is DC type, including a DC power source, or a single-phase grid power source with a rectifier, or a multiple-phase grid power source with rectifier. An example power source configuration includes a DC source in a medium-voltage range of 600 V to 2000 V. The power source 150 may supply power to the power supply 10 via an input port thereof.

Given the MV input voltage, a transformer 112 of the power supply 10 may be used to provide both electrical isolation and the turns ratio scale to deliver a low-voltage (LV) level to a cascaded regulation stage. As per IEC 60950, the isolation requirement is 5 kV (2 times operating voltage plus 1 kV). A resonant circuit 121 (e.g., a resonant tank) of the power supply 10 may enhance efficiency in this stage by enabling soft switching in switching circuitry 116 and offering a sinusoidal-like primary current for the transformer 112.

The power supply 10 may include switching circuitry 116 (e.g., a half-bridge circuit) with a plurality of switches that are controllable to generate AC power based on DC power obtained via power from the power source 150. It is to be understood that the switching circuitry 116 of the power supply 10 is not limited to a half-bridge circuit-any type of switching circuit may be utilized with a plurality of switches operable to generate AC power based on power from the power source. For instance, a full bridge circuit may be used in place of the half bridge circuit.

The switching circuitry 116 may correspond to a DC/AC inverter coupled between the input port of the power supply 10 and a resonant circuit 121. The switching circuitry 116 may be configured to produce, from the DC voltage across the input port of the power supply 10, a square voltage waveform at a switching frequency for exciting the resonant circuit 121.

The power supply 10 in the illustrated embodiment includes a control circuit 140 operably coupled to the switching circuitry 116. The control circuit 140 may direct operation of the switching circuitry 116 to operate a switching frequency that matches a resonant frequency of the resonant circuit 121.

The control circuit 140 and/or the switching circuitry 116 may include drive circuitry, such as a multiplexor or signal conditioning circuitry, or both, in the form of a gate driver interface to translate output from the control circuit 140 to direct operation of the switching circuitry 116. Alternatively, the drive circuitry may correspond to pass through conductors that provide a direct connection between the switching circuitry 116 and the control circuit 140.

The power supply may include a resonant circuit 121 having a resonant frequency. The resonant circuit 121 may be configured in a variety of ways, and is not limited to those described in conjunction with the embodiments of FIGS. 1-3. For example, the resonant circuit 121 may be configured in any manner, including a series-series, series-parallel, parallel-series, and parallel-parallel, or higher order resonant tuning networks, or any combination thereof.

The switching circuitry 116 may be configured to receive input power from the power source 150, and to generate AC power to be supplied to the transformer 112. The control circuit 140 may direct operation of the switching circuitry 116 according to a switching frequency and duty cycle (pulse width) to generate the AC power for the transformer 112. The switching frequency may be operated between few kilo-hertz to 300 kHz, and may optionally be about 50 kHz. In one embodiment, the control circuit 140 may be operable to vary a switching frequency of the switching circuitry 116.

The switching circuitry 116 may be provided in a half bridge configuration with first and second switches Q1, Q2 operable to provide power to the transformer 112. The switches Q1, Q2 may be MOSFETs or any other type of switch capable of selectively supplying power to the transformer 112, including for example IGBTs.

The control circuit 140 may include electrical circuitry and components to carry out the functions and algorithms described herein. Generally speaking, the control circuit 140 may include one or more microcontrollers, microprocessors, digital signal processors (DSP), and/or other programmable electronics that are programmed to carry out the functions described herein. The control circuit 140 may additionally or alternatively include other electronic components that are programmed to carry out the functions described herein, or that support the microcontrollers, microprocessors, and/or other electronics. The other electronic components include, but are not limited to, one or more field programmable gate arrays (FPGAs), systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the system or aspects thereof, or they may reside in a common location within the power supply or an aspect thereof. When physically distributed, the components may communicate using any suitable serial or parallel communication protocol, such as, but not limited to, CAN, LIN, Vehicle Area Network (VAN), FireWire, I2C, RS-232, RS-485, Ethernet, LAN, WiFi, and Universal Serial Bus (USB).

In the illustrated embodiment of FIG. 1, the resonant circuit 121 is configured as an LLC compensation circuit, including a first inductor Lr, a second inductor Lm, and a capacitor Cr. The inductor Lr can be integrated into the transformer design, as the transformer leakage inductance. As described herein, the resonant circuit 121 may be configured differently, such that the present disclosure is not limited to an LLC resonant circuit configuration.

The transformer 112 of the power supply 10 may include a primary coil Np and a secondary coil Ns joined physically by a core. The transformer 112 may enable transfer of power between the primary coil Np and the secondary coil Ns without a direct electrical connection therebetween. The transformer 112 may include a tertiary coil Nt operable to generate power based on power supplied to the primary coil Np. The power output from the tertiary coil Nt may be used as a basis for powering the control circuit 140, and optionally providing sensor feedback indicative of operation of the transformer 112. For instance, based on sensor feedback from the tertiary coil Nt, the control circuit 140 may vary operation of the switching circuitry 116 (e.g., vary a switching frequency and/or a duty cycle).

The primary coil Np (or primary winding) of the transformer 112 may be electrically connected to the resonant circuit 121 and configured to receive a primary voltage waveform at the switching frequency from the resonant circuit 121 excited with the voltage square waveform from the switching circuitry 116. The secondary coil Ns (or secondary winding) may be magnetically coupled with the primary coil Np and configured to produce a secondary voltage waveform at the switching frequency and corresponding to the primary voltage waveform.

The tertiary coil Nt (or tertiary winding) may be coupled to the primary coil Np in a manner similar to the coupling between the secondary coil Ns and the primary coil Np (e.g., physically coupled via a core but electrically isolated from each other). For instance, the tertiary coil Nt winding magnetically coupled with the primary winding and configured to produce a tertiary voltage waveform at the switching frequency and corresponding to the primary voltage waveform.

The transformer 112 configuration may vary from application to application. Several aspects may be considered for the transformer 112 configuration, including the input-output voltage ratio, a low coupling capacitance, and/or a magnetizing current around 30% of the input current. Parameters for the transformer construction according to one embodiment are shown in Table 1.

A ferrite core may be utilized in one embodiment. Although resonant converters can operate in higher switching frequency without penalty on the switching losses, core losses may be considered to define the switching frequency as 50 KHz.

TABLE 1

| Parameter | Value |
|---|---|
| Input voltage | 0.3-1 kV (Vdc/2) |
| Core | Ferrite PQ 40 × 40 |
| Np | 75 turns |
| Ns | 8 turns |
| Nt | 3 turns |
| Magnetizing inductance | Lₘ = 23 mH |
| Coupling capacitance | Cₚ = 13 pF |
| Leakage inductance | Lₗ = 608 μH |
| Primary and tertiary gauge | AWG 24 |
| Secondary gauge | AWG 19 |

In MV applications, the parasitic effects can become significant due to the high dV/dt, hence the primary and secondary coils Np, Ns may be separated in the bobbin in order to achieve a low coupling capacitance. Indeed, this approach effectively reduced Cp and contributes to the isolation, however the leakage inductance may be increased in this circumstance. Since this inductance may be impactful, it is to be considered when designing the resonant inductor (Lr) since it is added in series.

As described herein, a tertiary coil Nt may be incorporated into the transformer 112 to provide power to the control circuit 140. However, since during the startup the tertiary coil Nt is not energized yet, the startup circuit 100 may be utilized to supply initial power until the tertiary circuit is energized.

The power supply 10 may include rectification circuitry 137 and converter circuitry 139 disposed between the tertiary coil Nt and the control circuit 140. The rectification circuitry 137 and the converter circuitry 139 may operate in conjunction with each other to condition power output from the tertiary coil Nt for powering the control circuit 140. As discussed herein, there may be a delay in supply of power from the tertiary coil Nt, the rectification circuitry 137, the converter circuitry 139, so that the startup circuit 100 may provide power to the control circuit 140 until after sufficient power can be obtained from the tertiary coil Nt—such as after the tertiary coil Nt produces the tertiary waveform.

The rectification circuitry 137 (e.g., an AC/DC rectifier) may be electrically connected between the tertiary coil Nt and the converter circuitry 139 (e.g., a DC/DC converter), where the rectification circuitry 137 is configured to produce, from the tertiary voltage waveform across the tertiary winding, an unregulated DC voltage. The converter circuitry 139 may be configured to regulate the unregulated DC voltage and power the control circuit 140 with a regulated DC voltage, such as about 17 V. The converter circuitry 139 may correspond to a buck/boost converter, but the present disclosure is not so limited—the converter circuitry 139 may be any type of converter circuitry, such as a boost converter or a buck converter.

The rectification circuit 80 may be electrically coupled to an output of a secondary coil Ns of the transformer 112 and is configured to convert an alternating current (AC) signal induced in the secondary coil Ns into a rectified voltage (e.g., a type of AC/DC rectifier). The rectification circuit 80 may be provided between the secondary coil Ns and a DC/DC converter 90, where the rectification circuit 80 is configured to produce, from a secondary voltage waveform across the secondary coil Ns, an unregulated DC voltage.

In one embodiment, the rectification circuit 80 includes one or more rectifying elements, such as diodes or controlled semiconductor switches, arranged to produce a full-wave or half-wave rectified output. The rectified output of the rectification circuit 80 may provide a DC voltage suitable for downstream power conditioning.

The DC/DC converter 90 is coupled to an output of the rectification circuit 80 and is configured to receive the rectified voltage derived from the secondary coil Ns of the transformer 112. The DC/DC converter 90 may operate to convert the rectified voltage to a regulated DC output having a target voltage and/or current characteristic. In one embodiment, the DC/DC converter 90 may be implemented as a buck, boost, buck-boost, or isolated converter topology, and may include one or more switching elements, energy storage components, and a control circuit to regulate the output supplied to a load. The present disclosure is not limited to use of a DC/DC converter 90—any type of load, including converter circuitry or the like, may be provided in place of the DC/DC converter 90.

The DC/DC converter 90, or other type of conditioning circuitry, may be operable to supply power to an output port of the power supply 10, which may be coupled to a downstream load. In one embodiment, the DC/DC converter 90 may be configured to regulate the unregulated DC voltage from the rectification circuit 80 and to provide regulated DC voltage across the output port of the power supply 10. As an example, the DC/DC converter 90 may be configured to provide 24 V across the output port of the power supply 10.

The startup circuit 100 according to one embodiment is shown in FIGS. 1 and 2. The startup circuit 100 includes an input 202 operably coupled to the power source 150 to receive power therefrom and an output port 204 operably coupled to the control circuit 140 to supply power to the control circuit 140.

In one embodiment, the startup circuit 100 may include a capacitive divider circuit 220 coupled to the input 202 so that the full voltage Vin across the input 202 is provided to the capacitive divider circuit 220. The capacitive divider circuit 220 may include a first capacitor C1 and a second capacitor C2 arranged so that a voltage VC2 across the second capacitor C2 is a portion of the voltage Vin based on an elapsed time after initial supply of the voltage Vin across the input 202 and the capacitances of the first and second capacitors C1, C2.

After an initial period of time (e.g., a delay) between initial supply of the voltage Vin and the voltage VC2 reaching a threshold level, a switch 210 may be activated to supply power to the output port 204, based on current supplied at the voltage VC2 to the switch 210. The switch 210 may be a relay, such as a MOSFET relay (e.g., an OMRON G3VM-61G3) with optical isolation between input and output sides of the relay. In this way, the startup circuit 100 may be operable to delay supply of power to the control circuit 140 relative to initial receipt of power from the input port based on a charge state of the second capacitor C2.

The startup circuit 100 may power the control circuit 140 until after the tertiary winding Nt produces a tertiary voltage waveform—e.g., after once the tertiary winding produces the tertiary voltage waveform, the startup circuit 100 may turn itself off. In this way, the startup circuit 100 may operate independent of the resonant circuit 121, the control circuit 140, and the switching circuitry 116.

In one embodiment, the startup circuit 100 may include a resistive divider circuit with a first resistor R1 and a second resistor R2 arranged with an output of the resistive divider circuit coupled to the input of the switch 210 to control activation of the switch 210. The resistive divider circuit may be disposed across the full voltage Vin of the input 202.

Current supplied at the voltage VC2 to the switch 210 may be selectively used to form the basis for power supplied to the output port 204 to operate the control circuit 140. For instance, power supplied at the voltage VC2 may be selectively supplied via the switch 210 to a diode D1, which in conjunction with a Zener diode Vz and a capacitor C3 may regulate power output from the output port 204.

In one embodiment, because the only source of energy is the DC input voltage from the power source 150, the startup circuit 100 may be utilized to power the control circuit 140 until after power can be obtained via the tertiary coil Nt.

One type of startup circuit includes a Zener shunt regulator. However, this configuration derives the power from the DC bus through a resistor, which can result in high power loss and thermal issues in case of high input voltages. Moreover, the startup current is continuously drawn from the input power bus, even during the steady-state operation. Additionally, this circuit is more suitable in case where the magnitude of input voltage is characterized as step because the resistor can be properly sized. In wide input range, tuning the Zener resistance is challenging.

The power supply 10 according to one embodiment can start operating at 600 V. As a result, the startup circuit 100 in one embodiment uses a different strategy from the Zener shunt regulator, as described herein in conjunction with FIGS. 1 and 2.

It is noted that the control circuit 140 in one embodiment is formed by a pulse generator IC (SG3525) and the gate-drivers. This circuit demands about 50 mA and a minimum of 8 V to operate.

The startup circuit 100 according to one embodiment includes a capacitive voltage divider, however, if the supply line of the control circuit 140 is directly connected to the capacitor C2, the control circuit 140 may draw a slight current, preventing the voltage from accumulating. Therefore, the switch 210 (e.g., a relay, such as G3VM-61G3) may be provided to allow the capacitor C2 to be charged before starting providing energy for the control circuit 140.

In one embodiment, considering a 50 mA startup current and a time of approximately 5 ms during which C₂ delivers energy, the value of C₂ can be calculated by eq. (1), where ΔV is the voltage variation across C₂ until the startup transient is finished.

$${C}_{2} = \frac{i \times Δ t}{Δ V} = \frac{50 mA \times 5 ms}{1} = 250 μ F \qquad ( 1 )$$

The nominal voltage for the control circuit 140 may be defined as 17 V (V_{Z}), therefore, the ratio between C₁ and C₂ may follow the same ratio as the Vᵢₙ and V_{C2}. Defining C₂=270 μF, C₁ is calculated as 8 μF.

$$\frac{{V}_{i n}}{{V}_{C 2}} = \frac{{C}_{2}}{{C}_{1}} ≅ 35 \qquad ( 2 )$$

The ratio between C₁ and C₂ may be tuned in such a way that when the DC bus reaches about 600 V, the voltage storage in C₂ is higher than the minimum voltage required by the control circuit 140 and the gate drivers to start. Meanwhile, the resistors R₁ and C₂ may be tuned to provide the driven current to an input (e.g., a photodiode) of the switch 210 at the same 600 V bus voltage. After a few pulses have been generated by the control circuit 140, the LLC converter starts operating, and the tertiary coil Nt may continue to power the control circuit 140. The voltage generated in the tertiary coil may be rectified and applied to the converter circuitry 139, such as regulator IC (AP3012KTR-G1), which may be operable to provide a constant 17 V to the control circuit 140. In steady-state condition, the capacitive divider startup circuit may be turned off because no current may flow in the capacitors without dV/dt. Although a current may continue to flow through the resistors, about 2 W is dissipated when the input voltage reaches 2 kV.

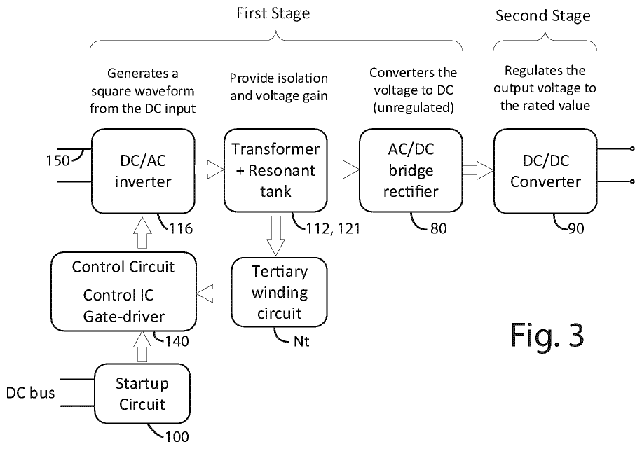

FIG. 3 depicts a block diagram of the various components of the power supply 10 according to one embodiment, including a power source 150 coupled to a DC/AC inverter or other type of converter circuit (e.g., the switching circuitry 116), a transformer and resonant tank circuit (e.g., the transformer 112 and the resonant circuitry 121), a rectifier circuit (e.g., the rectifier 80), and a DC/DC converter or other type of load or converter circuit (e.g., the DC/DC converter 90). The power supply 10 may also include a tertiary coil circuit (e.g., including the tertiary coil Nt and regulation circuitry, such as the rectifier 137 and converter 139), as well as a control circuit (e.g., the control circuit 140) and the startup circuit 100.

The effectiveness of the power supply 10 according to one embodiment has been verified by experimental tests at input voltage up to 1.4 kV. Table II lists the parameters and components of a power supply 10 according to one such experiment.

TABLE 2

| Parameter | Value | |
|---|---|---|
| Input voltage | 0.6-2 | kV |
| Output voltage | 24 | V |
| Output power | 100 | W |
| Switching frequency | 50 | kHz |

| | |
|---|---|
| Control circuit 140 | SG3525 |
| Gate-Drivers for switching | MIC4420, UCC23514SDWVR |
| circuitry 116 | |
| Switching circuitry 116 (e.g., half- | IXTF1R4N450 |
| bridge switches) | |
| Resonant circuit 121 (e.g., resonant | Lᵣ = 470 μH, Cᵣ = 10 nF |
| tank) | |

The resonant circuit 121 is based on the resonant frequency of 50 kHz. Defining Cr=10 nF and taking the leakage inductance of the transformer 112 into consideration, the resonant inductor Lr is calculated as Lr=400 μH. A ferrite toroidal core was used to construct the inductor.

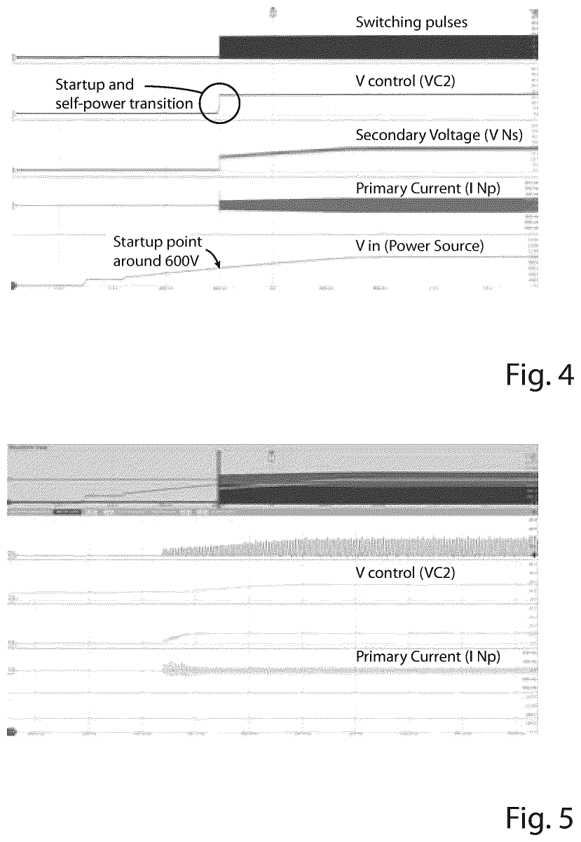

FIG. 4 illustrates the power supply startup process with the input voltage up to 1 kV. As can be seen, startup in this configuration occurs when the magnitude of the input voltage reaches about 600 V.

A zoomed version of FIG. 4 is shown in FIG. 5, revealing that, firstly, the voltage across the capacitor C2 of the startup circuit 100 is stored until approximately 10 V (signal identified as VC2), then during the startup process this voltage is temporarily supplied to the control circuit 140 and the switching signals are obtained (switching pulses for the switching circuitry 116).

When this occurs, the transformer 112 starts to deliver voltage through the secondary (Vout) and tertiary coils Ns, Nt, which maintain operating conditions and build up the control voltage to a target value (e.g., 17 V) via the output from the tertiary coil Nt. During the starting process, a peak current of 0.4 A in the experimental version of the power supply 10 has been observed.

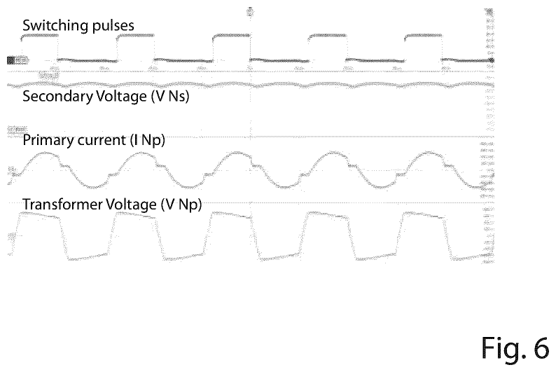

FIG. 6 shows the main waveforms of the power supply 10 operating in steady state with a 15Ω resistive load connected in the secondary coil Ns. As can be seen, driving the switching circuitry 116 with 50% duty cycle, a square wave voltage is applied to the resonant circuit 121, however, a more sinusoidal-like current waveform circulates in the primary coil Np.

Additionally, a deadtime of 2 μs may be set between the low and upper switching events, both to prevent the possibility of cross-conduction and to allow time for zero voltage switching to be achieved.

In one embodiment, a voltage regulation module (e.g., the rectifier circuitry 80 and converter circuitry 90) can be connected as a second stage to provide a rated output voltage from the power supply 10. In addition, a synchronous rectifier (SR) can be applied to the output of the transformer 112 to improve the efficiency.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A power supply comprising:
an input port configured to be connected to DC voltage in a medium-voltage range of 600-2000 V;
a resonant circuit having a resonant frequency in a frequency range of 10-300 kHz;
a control circuit;
a DC/AC inverter electrically connected between the input port and the resonant circuit and operationally connected to the control circuit, wherein the control circuit is configured to operate the DC/AC inverter at a switching frequency that matches the resonant frequency, wherein the DC/AC inverter is configured to produce, from the DC voltage across the input port, a voltage square waveform at the switching frequency for exciting the resonant circuit;
a transformer including:
a primary winding electrically connected to the resonant circuit and configured to receive a primary voltage waveform at the switching frequency from the resonant circuit excited with the voltage square waveform; and
a secondary winding magnetically coupled with the primary winding and configured to produce a secondary voltage waveform at the switching frequency and corresponding to the primary voltage waveform;
a DC/DC converter;
an AC/DC rectifier electrically connected between the secondary winding and the DC/DC converter, wherein the AC/DC rectifier is configured to produce, from the secondary voltage waveform across the secondary winding, an unregulated DC voltage;
an output port electrically connected to the DC/DC converter, wherein the DC/DC converter is configured to regulate the unregulated DC voltage, and provide regulated DC voltage across the output port; and
startup circuitry operable to supply power to the control circuit to initiate supply of control signals to operate the DC/AC inverter at the switching frequency, the startup circuitry including a capacitive divider circuit including a first capacitor and a second capacitor operable to charge based on power from the input port, the startup circuitry operable to delay supply of power to the control circuit relative to initial receipt of power from the input port based on a charge state of the second capacitor.

2. The power supply of claim 1, wherein, by delaying supply of power to the control circuit, the startup circuitry delays initiation of supply of control signals to operate the DC/AC inverter at the switching frequency.

3. The power supply of claim 1, wherein the startup circuitry powers the control circuit until a tertiary winding produces a tertiary voltage waveform and turns itself off once the tertiary winding produces the tertiary voltage waveform.

4. The power supply of claim 1, wherein the startup circuitry delays supply of power to the control circuit until the second capacitor of the capacitive divider circuit reaches a threshold charge voltage.

5. The power supply of claim 1, wherein the startup circuitry operates independent of the resonant circuit, the control circuit, and the DC/AC inverter.

6. The power supply of claim, wherein
the transformer comprises a tertiary winding magnetically coupled with the primary winding and configured to produce a tertiary voltage waveform at the switching frequency and corresponding to the primary voltage waveform,
the power supply further comprises
another DC/DC converter, and
another AC/DC rectifier electrically connected between the tertiary winding and the other DC/DC converter, wherein the other AC/DC rectifier is configured to produce, from the tertiary voltage waveform across the tertiary winding, another unregulated DC voltage, and
the other DC/DC converter is configured to regulate the other unregulated DC voltage and power the control circuit with another regulated DC voltage.

7. The power supply of claim 6, wherein the other regulated DC voltage used by the other DC/DC converter to power the control circuit is about 17 V.

8. The power supply of claim 6, wherein the startup circuitry is configured to:
power the control circuit until the tertiary winding produces the tertiary voltage waveform, and
turn itself off once the tertiary winding produces the tertiary voltage waveform.

9. The power supply of claim 1, wherein the DC/DC converter is configured as a buck converter.

10. The power supply of claim 1, wherein the resonant circuit is configured as an LLC resonator.

11. The power supply of claim 1, wherein the regulated DC voltage provided by the DC/DC converter across the output port is about 24 V.

12. A power supply comprising:
an input port configured to be connected to DC voltage;
a resonant circuit having a resonant frequency;
a control circuit;
an inverter electrically connected between the input port and the resonant circuit and operationally connected to the control circuit, wherein the control circuit is configured to operate the inverter at a switching frequency aligned with the resonant frequency;
a transformer including:
a primary winding electrically connected to the resonant circuit and configured to receive a primary voltage waveform at the switching frequency from the resonant circuit; and
a secondary winding magnetically coupled with the primary winding and configured to produce a secondary voltage waveform at the switching frequency and corresponding to the primary voltage waveform;
a load;
a rectification circuit electrically connected between the secondary winding and the load, wherein the rectification circuit is configured to supply power to the load based on power derived from the secondary voltage waveform across the secondary winding.

13. The power supply of claim 12, wherein, by delaying supply of power to the control circuit, the startup circuitry delays initiation of supply of control signals to operate the inverter at the switching frequency.

14. The power supply of claim 12, wherein the startup circuitry powers the control circuit until a tertiary winding produces a tertiary voltage waveform and turns itself off once the tertiary winding produces the tertiary voltage waveform.

15. The power supply of claim 14, wherein the control circuit obtains power during operation based on the tertiary voltage waveform output from the tertiary winding.

16. The power supply of claim 12, wherein the startup circuitry delays supply of power to the control circuit until the second capacitor of the capacitive divider circuit reaches a threshold charge voltage.

17. The power supply of claim 12, wherein the startup circuitry operates independent of the resonant circuit, the control circuit, and the inverter.

18. The power supply of claim 12, wherein the inverter circuitry includes half-bridge driver circuitry.

19. The power supply of claim 12, wherein the load includes a DC/DC converter operable to regulate power output from the rectification circuitry for supply to an output port.

20. The power supply of claim 12, wherein the resonant circuit is an LLC resonator.
